(19) United States
(12) Patent Application Publication
(10) Pub. No.: US 2004/0020900 A1
(43) Pub. Date: Feb. 5, 2004

(54) Plasma arc torch

(76) Inventor: Chun-Fu Wu, Tao-Yuan Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/210,613

(22) Filed: Jul. 31, 2002

(51) Int. Cl. B23K 10/00

(52) U.S. Cl. 219/121.5; 219/121.51

(57) ABSTRACT

A plasma arc torch includes an electrode device with an elongated electrode carrier which has a first end mounted rotatably in a housing and an opposite second end extending outwardly of the housing and mounted with an electrode body. A drive unit is mounted in the housing, and is connected operably to the electrode carrier for driving axial rotation of the electrode carrier. A nozzle, which confines a gas chamber, is mounted on the housing and is disposed adjacent to the electrode body. A gas guiding unit is provided for guiding plasma gas into the nozzle.

### BACKGROUND OF THE INVENTION

1. Field of the Invention

The present invention relates to a plasma arc torch, more particularly to a plasma arc torch with a rotatable electrode that has coolant fluid circulating therein.

2. Description of the Related Art

Plasma arc torches have been widely used in the art for cutting a workpiece by creating a plasma arc so as to apply heat to the workpiece. A conventional plasma arc torch generally includes an electrode connected electrically to a negative pole of a power supply, and a nozzle disposed around the electrode to form a gas chamber between the electrode and the nozzle. An ionizable plasma gas is introduced into the gas chamber and is guided to swirl around the electrode. A workpiece to be cut is disposed adjacent to the nozzle, and is connected to a positive pole of the power supply. As known to those skilled in the art, an electric arc created between the electrode and the workpiece, together with the ionizable plasma gas flowing around the electrode, causes a plasma arc to be generated and applied onto the workpiece. The swirling flow of the plasma gas imparts a circular vector to the plasma arc created between the electrode and the workpiece and thus concentrates the application of heat on the workpiece.

### SUMMARY OF THE INVENTION

An object of the present invention is to provide a plasma arc torch with a rotatable electrode so as to generate a plasma arc with a swirling vector for constricting and accelerating the plasma arc toward the workpiece.

Another object of the present invention is to provide an electrode device for use in a plasma arc torch.

According to one aspect of the present invention, a plasma arc torch includes a housing, an electrode device, a drive unit, a nozzle and a gas guiding unit. The housing is formed with an opening. The electrode device includes an elongated electrode carrier which has a first end disposed in the housing, a second end opposite to the first end and extending outwardly of the housing via the opening, and a longitudinal axis. The electrode carrier is mounted rotatably on the housing so as to be rotatable about the longitudinal axis relative to the housing. The electrode device further has an electrode body mounted on the second end of the electrode carrier. The drive unit is mounted in the housing, and is connected operably to the first end of the electrode carrier for driving axial rotation of the electrode carrier relative to the housing. The nozzle is mounted on the housing, and is disposed adjacent to the electrode body. The gas guiding unit guides plasma gas into the nozzle.

According to another aspect of the present invention, an electrode device for a plasma arc torch includes a tubular electrode carrier, an electrode body, a fluid tube, and first and second sealing members. The electrode carrier has opposite first and second ends and an inner surface which confines an axial hole that opens at the first and second ends. The electrode carrier is formed with a radial inlet hole unit and a radial outlet hole unit which is displaced axially from the inlet hole unit. The electrode body is mounted on the second end of the electrode carrier. The fluid tube is disposed within the axial hole, and confines a first fluid passage that has an open first end disposed adjacent to the inlet hole unit, and an open second end disposed adjacent to the electrode body. The fluid tube has an outer surface which is spaced apart from the inner surface of the electrode carrier so as to define a second fluid passage between the electrode carrier and the fluid tube. The first fluid passage is communicated with one of the inlet and outlet hole units. The second fluid passage is communicated with the other one of the inlet and outlet hole units. The electrode body confines a fluid chamber that intercommunicates the first and second fluid passages. The first sealing member is sleeved on the fluid tube, and is disposed between the inlet and outlet hole units to prevent flow of fluid between the inlet and outlet hole units. The second sealing member is provided in the first end of the electrode carrier to prevent flow of fluid out of the electrode carrier via the first end of the electrode carrier.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded sectional view of a preferred embodiment of the plasma arc torch of the present invention;

FIG. 2 is a sectional view of the preferred embodiment;

FIG. 3 is a partly cut-away, inverted perspective view showing a plug member of an electrode device of the preferred embodiment; and

FIG. 4 is a perspective view showing an inner tube of a gas guiding unit of the plasma arc torch of the preferred embodiment.

### DETAILED DESCRIPTION OF THE PREFERRED EMBODIMENT

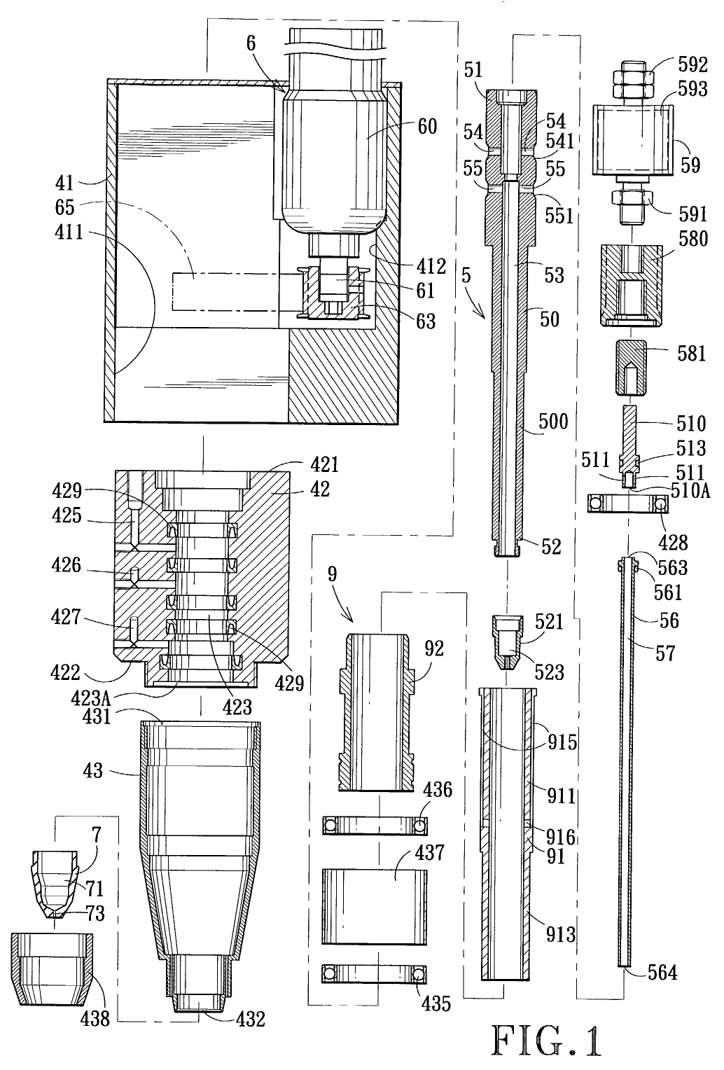

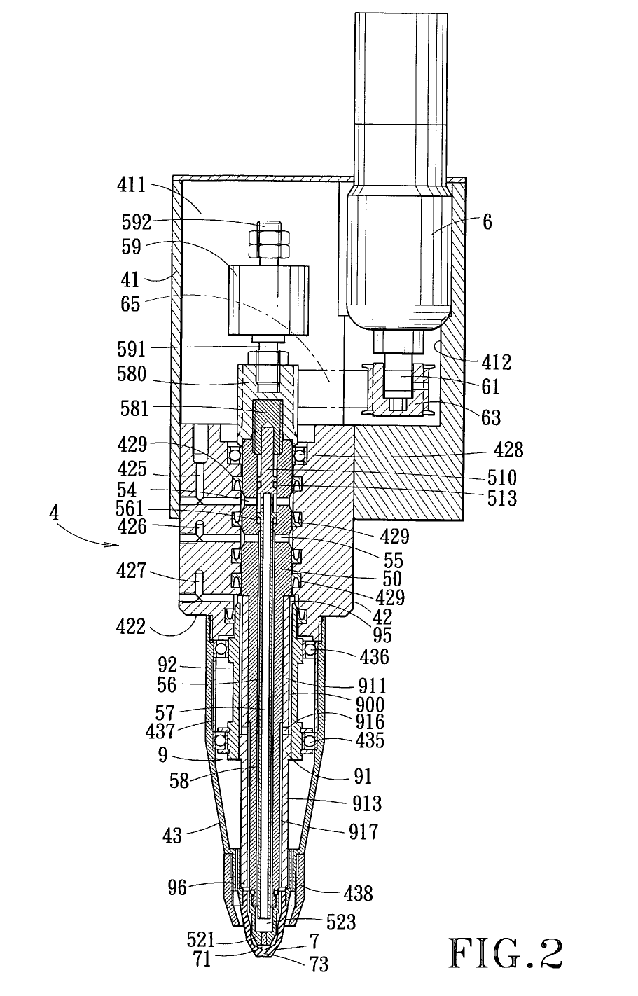

Referring to FIGS. 1 and 2, the preferred embodiment of the plasma arc torch according to the present invention is shown to include a housing 4, an electrode device 5, a drive unit 6, a nozzle 7, and a gas guiding unit 9. The plasma arc torch of the present invention is adapted to be connected electrically to a negative pole of an electric power source (not shown). A workpiece (not shown) to be cut by the plasma arc torch is connected to a positive pole of the electric power source such that an electric arc is created, in a known manner, between the torch and the workpiece when the electric power source is turned on.

The housing 4 includes a first housing member 41 and a cylindrical second housing member 42. The second housing member 42 may be fastened to the first housing member 41 by screw fasteners (not shown). The first housing member 41 is formed with a first mounting cavity 411 and a second mounting cavity 412 communicated with the first mounting cavity 411. The second housing member 42 is fitted into an open end of the first housing member 41 adjacent to the first mounting cavity 411, and has a first end 421 facing the first mounting cavity 411, and a second end 422 opposite to the first end 421. A mounting hole 423 is formed through the second housing member 42 and is communicated with the first mounting cavity 411. The mounting hole 423 has an opening 423A formed at an end wall on the second end 422 of the second housing member 42. The second housing member 42 is further formed with first and second coolant channels 425, 426, and a gas channel 427. Each of the coolant channels 425, 426, 427 and the gas channel 427 has one end opening at an end wall of the first end 421 for communicating with the first mounting cavity 411 in the first housing member 41, and another end opening at an annular hole-defining wall that defines the mounting hole 423 for communicating with the mounting hole 423.

A coupling sleeve 43 is coupled to the second end 422 of the second housing member 42 around the opening 423A. The coupling sleeve 43 has an open first end 431 connected threadedly to the second end 422 of the second housing member 42, and an open second end 432 opposite to the first end 431, and converges slightly and gradually from the first end 431 to the second end 432. The second end 432 of the coupling sleeve 43 has the nozzle 7 mounted thereon for mounting the nozzle 7 to the housing 4. The nozzle 7 extends into the second end 432 of the coupling sleeve 43, and is threaded to an inner wall surface of the second end 432 of the coupling sleeve 43. The nozzle 7 confines a gas chamber 71 therein, and is formed with a constricted central hole 73.

A ceramic sleeve 438 is sleeved on the second end 432 of the coupling sleeve 43 so as to extend from the second end of the coupling sleeve 43. The ceramic sleeve 438 is resistant to high temperatures, and is disposed around the nozzle 7.

The electrode device 5 includes a tubular electrode carrier 50 having a first end 51, a secondend52 opposite to the first end 51, and a tubular wall 500 with an inner surface which defines an axial hole 53 that opens at the first and second ends 51, 52 of the electrode carrier 50. The electrode carrier 50 has a first section proximate to its first end 51 and formed with a radial inlet hole unit which includes four angularly displaced radial inlet holes 54 that extend radially through the tubular wall 500 of the electrode carrier 50. The first section of the electrode carrier 50 is further formed with a radial outlet hole unit which includes four angularly displaced radial outlet holes 55 that extend radially through the tubular wall 500 of the electrode carrier 50 and that are displaced axially and respectively from the inlet holes 54. The electrode carrier 50 further has a second section proximate to its second end 52. The first section of the electrode carrier 50 is disposed within the mounting hole 423 of the second housing member 42 and is mounted rotatably on the second housing member 42 via a ball bearing 428 provided between an outer surface of the electrode carrier 50 and an inner surface of the second housing member 42. A plurality of piston rings 429 are provided around the mounting hole 423 in the second housing member 42 so as to be disposed around the electrode carrier 50 and between the electrode carrier 50 and the second housing member 42. The second section of the electrode carrier 50 extends outwardly of the second housing member 42 via the opening 423. The first section of the electrode carrier 50 has an outer surface formed with a first annular recess 541 that has the inlet holes 54 disposed therein, and a second annular recess 551 that is displaced axially from the first annular recess 541 and that has the outlet holes 55 disposed therein. The first annular recess 541 is registered with an open end of the first coolant channel 425 for communicating the inlet holes 54 with the first coolant channel 425. The second annular recess 551 is registered with an open end of the second coolant channel 425 for communicating the outlet holes 55 with the second coolant channel 426. An electrode body 521 is sleeved threadedly on the second end 52 of the electrode carrier 50, and confines a fluid chamber 523 that is communicated with the axial hole 53 in the electrode carrier 50.

A fluid tube 56 is disposed within the axial hole 53 of the electrode carrier 50. The fluid tube 56 has a first end 563 disposed proximate to the first end 51 of the electrode carrier 50 and adjacent to the inlet holes 54 of the electrode carrier 50, and an opposite second end 564 projecting relative to the second end 52 of the electrode carrier 50 and extending into the fluid chamber 523 in the electrode body 521. The fluid tube 56 defines a first fluid passage 57 that opens at the first and second ends 563, 564 of the fluid tube 56 for communicating with the inlet holes 54 and the fluid chamber 523. The fluid tube 56 has an outer surface that is spaced apart from the inner surface of the electrode carrier 50 so as to define a second fluid passage 58 between the electrode carrier 50 and the fluid tube 56. The second fluid passage 58 is communicated with the outlet holes 55 of the electrode carrier 50. The fluid chamber 523 intercommunicates the first and second fluid passages 57, 58. A first sealing ring 561 is sleeved on the fluid tube 56, and is disposed between the inlet and outlet holes 54, 55 to prevent flow of fluid between the inlet and outlet holes 54, 55 along the outer surface of the fluid tube 56.

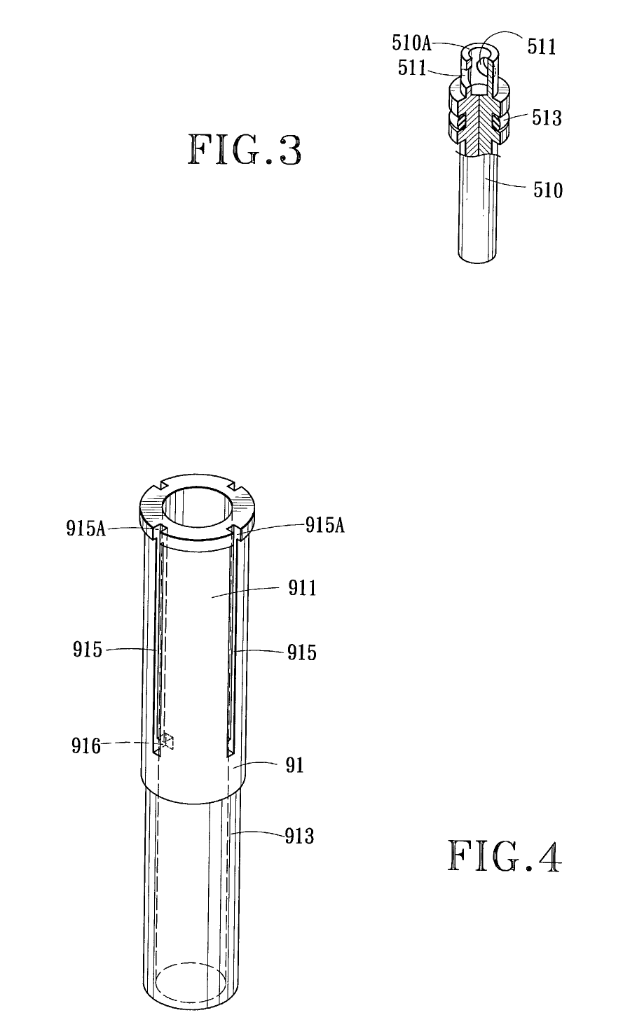

With further reference to FIG. 3, an elongated plug member 510 is disposed at the first end 51 of the electrode carrier 50, and extends into the axial hole 53. The plug member 510 has a tubular end portion 510A which abuts against the first end 563 of the fluid tube 56 and which is formed with diametrically opposite radial slots 511 registered with the inlet holes 54 of the electrode carrier 50 for communicating the first fluid passage 56 with the inlet holes 54. A second sealing ring 513 is sleeved on the plug member 510 to prevent flow of fluid into the first mounting cavity 411 via the first end 51 of the electrode carrier 50.

A coolant fluid (not shown) can be guided into the first fluid passage 57 of the electrode carrier 50 via the first coolant channel 425, the inlet holes 54 and the radial slots 511 for cooling the electrode carrier 50 during operation of the plasma arc torch. The coolant fluid is allowed to flow through the first fluid passage 57, the fluid chamber 523 and into the second fluid passage 58. Then, the coolant fluid is guided away from the electrode carrier 50 via the second fluid passage 58, the outlet holes 55 and the second coolant channel 426.

A cylindrical coupling member 581 is fastened to the first end 51 of the electrode carrier 50, and extends into the axial hole 53. The coupling member 581 is disposed around and abuts against an end portion of the plug member 510 opposite to the tubular end portion 510A for positioning the plug member 510 within the axial hole 53. The coupling member 581 has an outer surface formed with an external screw thread to engage threadedly the inner surface of the electrode carrier 50 at the first end 51 of the latter, and to engage threadedly a conductive roller 580 for coupling the roller 580 co-rotatably on the first end 51 of the electrode carrier 50.

The drive unit 6 is mounted in the second mounting cavity 412 of the first housing member 41, and includes a drive motor 60, a transmission shaft 61 extending from the drive motor 60, a rotary wheel 63 sleeved securely on the transmission shaft 61, and a transmission belt 65 extending between the roller 580 and the rotary wheel 63 for transmitting rotation of the rotary wheel 63 to the roller 580 so as to drive axial rotation of the electrode carrier 50.

An electrical connector 59 is provided in the first mounting cavity 411 of the first housing member 41 for connecting the electrode carrier 50 to the electric power source. The electrical connector 59 has a rotatable electrode connecting end 591 that is connected threadedly to the roller 580 for coupling co-rotatably to the electrode carrier 50, a stationary source connecting end 592 adapted to be connected to the negative pole of the power source, and a conductive liquid body 593 provided between the electrode connecting end 591 and the source connecting end 592 to establish electrical connection between the electrode connecting end 591 and the source connecting end 592, thereby connecting the electrode carrier 50 to the negative pole of the power source.

Referring to FIGS. 1, 2, 4, the gas guiding unit 9 is sleeved on the second section of the electrode carrier 50 and is disposed within the coupling sleeve 43. The gas guiding unit 9 includes an electrically insulating inner tube 91 sleeved co-rotatably on the second section of the electrode carrier 50, and an outer tube 92 sleeved co-rotatably on the inner tube 91 such that gas guiding unit 9 has a first end 95 extending into the second housing member 42, and a second end 96 opposite to the first end 95 and disposed adjacent to the nozzle 7. A pair of ball bearings 435, 436 are provided between an outer surface of the outer tube 92 of the gas guiding unit 9 and an inner surface of the coupling sleeve 43. A spacer ring 437 is disposed around the outer tube 92 and between the ball bearings 435, 436. The inner tube 91 has a first section 911 in close contact with the electrode carrier 50, and a second section 913 connected to the first section 911. The electrode carrier 50 has a cross-section which is restricted at a portion corresponding to the second section 913 of the inner tube 91 such that a clearance 917 is formed between the electrode carrier 50 and the second section 913 of the inner tube 91. As shown in FIG. 4, the first section 911 of the inner tube 91 is formed with four angularly displaced and axially extending gas slots 915, each of which has an open end 915A formed at the first end 95 of the gas guiding unit 9 and each of which penetrates a tubular wall of the inner tube 91 at the junction of the first and second sections 911, 913 to communicate with the clearance 917 between the electrode carrier 50 and the inner tube 91. The outer tube 92 is sleeved on the first section 911 of the inner tube 91 to cover the circumferential surface of the latter. In this manner, a gas passage 900 is defined among the inner and outer tubes 91, 92 of the gas guiding unit 9 and the electrode carrier 50. The gas passage 900 extends from the first end 95 to the second end 96 of the gas guiding unit 9, and is communicated with the gas chamber 71 within the nozzle 7. The gas passage 900 is constituted by an axially extending first section which is formed by the gas slots 915 and which is defined between the inner and outer tubes 91, 92, an axially extending second section formed by the clearance 917 and communicated with the gas chamber 71, and a radial section 916 formed radially through the tubular wall of the inner tube 91 and intercommunicating the first and second sections 915, 917 of the gas passage 900. The open ends 915A are registered with the gas channel 427 in the second housing member 42 so as to permit a plasma gas to be guided into the gas chamber 71 and around the electrode body 521 via the gas channel 427 and the gas passage 900.

In operation, the drive unit 6 is activated to drive axial rotation of the electrode carrier 5 relative to the first and second housing members 41, 42 and the coupling sleeve 43 so as to impart a rotary vector to the electric arc created between the electrode body 521 and the workpiece. As such, the plasma arc formed by the electric arc, which ionizes the plasma gas around the electrode body 521, can be constricted to concentrate the application of heat on the workpiece, thereby allowing the cutting operation to be performed in a fine and precise manner.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A plasma arc torch comprising:
a housing formed with an opening;
an electrode device including an elongated electrode carrier which has a first end disposed in said housing, a second end opposite to said first end and extending outwardly of said housing via said opening, and a longitudinal axis, said electrode carrier being mounted rotatably on said housing so as to be rotatable about said longitudinal axis relative to said housing, said electrode device further having an electrode body mounted on said second end of said electrode carrier;
a drive unit mounted in said housing and connected operably to said first end of said electrode carrier for driving axial rotation of said electrode carrier relative to said housing;
a nozzle mounted on said housing and disposed adjacent to said electrode body; and
a gas guiding unit for guiding plasma gas into said nozzle.

2. The plasma arc torch as claimed in claim 1, wherein said electrode carrier is tubular and has an inner surface that confines an axial hole, said electrode carrier being formed with a radial inlet hole unit and a radial outlet hole unit which is displaced axially from said inlet hole unit, said electrode device further including a fluid tube disposed within said axial hole and confining a first fluid passage that has an open first end disposed adjacent to said inlet hole unit, and an open second end opposite to said first end of said fluid tube and disposed adjacent to said electrode body, said fluid tube having an outer surface which is spaced apart from said inner surface of said electrode carrier so as to define a second fluid passage between said electrode carrier and said fluid tube, said first fluid passage being communicated with one of said inlet and outlet hole units, said second fluid passage being communicated with the other one of said inlet and outlet hole units, said electrode body confining a fluid chamber that intercommunicates said first and second fluid passages, said electrode device further including a first sealing member sleeved on said fluid tube and disposed between said inlet and outlet hole units to prevent flow of fluid between said inlet and outlet hole units, and a second sealing member provided in said first end of said electrode carrier to prevent flow of fluid into said housing.

3. The plasma arc torch as claimed in claim 2, wherein said electrode device further includes a plug member disposed at said first end of said electrode carrier and extending into said axial hole, said second sealing member being sleeved on said plug member.

4. The plasma arc torch as claimed in claim 2, wherein said inlet hole unit includes a plurality of radial inlet holes communicated with said axial hole of said electrode carrier, said outlet hole unit including a plurality of radial outlet holes which are communicated with said axial hole of said electrode carrier.

5. The plasma arc torch as claimed in claim 4, wherein said electrode carrier has an outer surface formed with a first annular recess and a second annular recess which is displaced axially from said first annular recess, said inlet holes being formed in said first annular recess, said outlet holes being formed in said second annular recess.

6. The plasma arc torch as claimed in claim 2, wherein said housing is formed with a first coolant channel communicated with said inlet hole unit of said electrode carrier for guiding coolant fluid into said electrode carrier, and a second coolant channel communicated with said outlet hole unit for guiding the coolant fluid away from said electrode carrier.

7. The plasma arc torch as claimed in claim 2, wherein said housing includes a first housing member formed with a first mounting cavity and a second mounting cavity communicated with said first mounting cavity, said first end of said electrode carrier extending into said first mounting cavity, said drive unit being mounted in said second mounting cavity.

8. The plasma arc torch as claimed in claim 7, wherein said electrode device further includes a roller coupled co-rotatably on said first end of said electrode carrier, said drive unit including a drive motor, a transmission shaft extending from said drive motor, a rotary wheel provided on said transmission shaft, and a transmission belt extending between said roller and said rotary wheel for transmitting rotation of said rotary wheel to said roller so as to drive axial rotation of said electrode carrier.

9. The plasma arc torch as claimed in claim 7, wherein said housing further includes a second housing member connected to said first housing member adjacent to said first mounting cavity, said second housing member being formed with said opening, said electrode carrier having a first section proximate to said first end of said electrode carrier and received in said second housing member, and a second section proximate to said second end of said electrode carrier and extending out of said second housing member via said opening, said first section being formed with said inlet and outlet hole units, said second housing member being formed with a first coolant channel communicated with said inlet hole unit of said electrode carrier for guiding a coolant fluid into said electrode carrier, and a second coolant channel communicated with said outlet hole unit for guiding the coolant fluid away from said electrode carrier.

10. The plasma arc torch as claimed in claim 9, further comprising bearing means provided between said second housing member and said first section of said electrode carrier for mounting said electrode carrier rotatably on said second housing member.

11. The plasma arc torch as claimed in claim 9, further comprising a coupling sleeve disposed around said second section of said electrode carrier, said coupling sleeve having a first end mounted on said second housing member adjacent to said opening, and a second end opposite to said first end of said coupling sleeve, said nozzle being mounted on said second end of said coupling sleeve so as to be mounted to said housing.

12. The plasma arc torch as claimed in claim 11, wherein said gas guiding unit is sleeved co-rotatably on said second section of said electrode carrier, said gas guiding unit having a first end extending into said second housing member and a second end opposite to said first end of said gas guiding unit and disposed adjacent to said nozzle, said gas guiding unit cooperating with said electrode device to define a gas passage that extends from said first end to said second end of said gas guiding unit and that is in fluid communication with said nozzle, said second housing member being formed with a gas channel communicated with said gas passage to permit flow of a plasma gas into said nozzle via said gas passage.

13. The plasma arc torch as claimed in claim 12, further comprising bearing means provided between said coupling sleeve and said gas guiding unit for mounting said gas guiding unit rotatably in said coupling sleeve.

14. The plasma arc torch as claimed in claim 12, wherein said gas guiding unit includes an inner tube with a tubular wall sleeved co-rotatably on said electrode carrier, and an outer tube sleeved co-rotatably on said inner tube, said gas passage including an axially extending first section defined between said inner and outer tubes and extending to said first end of said gas guiding unit, an axially extending second section defined between said inner tube and said electrode carrier and in fluid communication with said nozzle, and a radial section formed radially through said tubular wall of said inner tube and intercommunicating said first and second sections.

15. The plasma arc torch as claimed in claim 11, further comprising a ceramic sleeve sleeved on said second end of said coupling sleeve and disposed around said nozzle.

16. The plasma arc torch as claimed in claim 1, further comprising an electrical connector which has an electrode connecting end coupled co-rotatably to said first end of said electrode carrier, a source connecting end adapted to be connected to a power source, and a conductive liquid body between said electrode connecting end and said source connecting end to establish electrical connection between said electrode connecting end and said source connecting end.

17. An electrode device for a plasma arc torch, comprising:
a tubular electrode carrier having opposite first and second ends and an inner surface which confines an axial hole that opens at said first and second ends, said electrode carrier being formed with a radial inlet hole unit and a radial outlet hole unit which is displaced axially from said inlet hole unit;
an electrode body mounted on said second end of said electrode carrier;
a fluid tube disposed within said axial hole and confining a first fluid passage that has an open first end disposed adjacent to said inlet hole unit, and an open second end disposed adjacent to said electrode body, said fluid tube having an outer surface which is spaced apart from said inner surface of said electrode carrier so as to define a second fluid passage between said electrode carrier and said fluid tube, said first fluid passage being communicated with one of said inlet and outlet hole units, said second fluid passage being communicated with the other one of said inlet and outlet hole units, said electrode body confining a fluid chamber that intercommunicates said first and second fluid passages;
a first sealing member sleeved on said fluid tube and disposed between said inlet and outlet hole units to prevent flow of fluid between said inlet and outlet hole units; and
a second sealing member provided in said first end of said electrode carrier to prevent flow of fluid out of said electrode carrier via said first end of said electrode carrier.
